(19) United States
(12) Patent Application Publication
(10) Pub. No.: US 2016/0229258 A1
(43) Pub. Date: Aug. 11, 2016

(54) HEATING, VENTILATION AND/OR AIR-CONDITIONING INSTALLATION FOR A MOTOR VEHICLE PASSENGER COMPARTMENT

(71) Applicant: Valeo Systemes Thermiques, Le Mesnil Saint-Denis (FR)

(72) Inventors: Didier Loup, Maurepas (FR); Amanda Martinell, Neauphle-Le-Château (FR); Philippe Vincent, Givrand (FR); Fabrice Ailloud, Guyancourt (FR)

(73) Assignee: Valeo Systemes Thermiques, Le Mesnil Saint Denis (FR)

(21) Appl. No.: 15/021,732

(22) PCT Filed: Sep. 9, 2014
(86) PCT No.: PCT/EP2014/069156

§ 371 Date: Mar. 14, 2016

(30) Foreign Application Priority Data
Sep. 19, 2013 (FR) 1358990

(51) Int. Cl. B60H 1/00; B60H 1/22

(52) U.S. Cl. CPC B60H 1/00064; B60H 1/00471; B60H 1/00392; B60H 1/00564; B60H 1/00678; B60H 1/2221; B60H 2001/00085; B60H 2001/00092; B60H 2001/00135

(57) ABSTRACT

The invention relates to a heating, ventilation and/or air-conditioning installation for a motor vehicle passenger compartment including a first air intake duct (5), a first air distribution duct (11) comprising at least one first air outlet (15a, 15b) that is in the passenger compartment and in communication with the first air intake duct (5), and a second air distribution duct (13) comprising a second air outlet (17). According to the invention, said installation (1) also includes a second intake duct (7) used exclusively for a recirculated air stream (FR2) coming from the passenger compartment that is in aeraulic communication with the second air distribution duct (13) so that the second air distribution duct (13) is supplied only by the recirculated air stream (FR2) coming from the second air intake duct (7).

The present invention relates to a heating, ventilation and/or air-conditioning installation for a motor vehicle passenger compartment enabling control of the temperature of the air stream in one or more zones of the passenger compartment of a motor vehicle.

Motor vehicles are typically fitted with a heating, ventilation and/or air-conditioning installation that is designed to regulate the aerothermal parameters of the air distributed inside the passenger compartment, in particular the temperature of an air stream delivered by the installation inside the passenger compartment.

In general, the installation comprises a casing delimited by partitions that are provided with openings, including at least one air inlet and at least one air distribution vent.

In a known manner, the casing usually contains an engine fan, also referred to as a blower, to cause the air stream to flow from the air inlet towards the air distribution vent. The casing also contains heat treatment means to heat and/or cool the air stream before same is distributed inside the passenger compartment through the air distribution vent. By way of example, the heat treatment means may include an evaporator that is designed to cool the air passing through same, and a radiator, which may be associated with an additional radiator, which is designed to heat the air passing through same.

The installation may also include several flaps designed to control the flow of air through the distribution vents corresponding to the ventilation or aeration outlets opening into the passenger compartment of the vehicle, or to a defogging/de-icing outlet, in particular for the windshield of the vehicle.

Furthermore, the air flowing through such an installation may be an external air stream or the air stream coming from the passenger compartment flowing back through the installation, the latter being referred to as a recirculated air stream, or a mix of the two. A mixing flap can alter the ratio of outside air to recirculated air.

If the outside temperature is low and the air stream coming from the passenger compartment is recirculated to heat the passenger compartment, there is a risk of mist forming on the windows of the vehicle, in particular on the windshield. Indeed, the presence of passengers in the passenger compartment increases the humidity of the recirculated air stream, which in time condenses on the windows if the outside temperature enables the dew point to be reached.

In order to avoid this problem, outside air that is drier than the recirculated air should preferably be blown into the passenger compartment.

However, this solution is not suitable for an electric vehicle, since the outside air is cold and a large amount of electrical energy is required to heat same, thereby potentially reducing the electric range of the vehicle.

In order to reduce electricity draw, it is preferable to use recirculated air from the passenger compartment for heating.

Two-level installations are known to overcome these problems, i.e. installations including two air distribution ducts containing the heat treatment means of a conventional installation to ensure thermal comfort inside the passenger compartment, in which each level can be supplied by an air stream for the same source or from a different source.

As such, the source of the air stream (outside air or recirculated air) can be selected as required, for example by sending an outside air stream to the windshield to overcome the issue of fogging on the windows of the vehicle, in particular the windshield, and sending a recirculated air stream to the footwell aeration outlets in the passenger compartment for quicker heating.

However, this solution requires a system for managing the air streams to distribute the outside and recirculated air streams as required.

Such a system is limiting because it requires bypass conduits to separate the air streams and to direct, for example, a recirculated air stream to the second level forming for example a lower portion of the installation while a new outside air stream has to be directed to the first level, in this case forming the upper portion of the installation. The presence of bypass conduits makes the installation more bulky within the vehicle.

Furthermore, such a system requires one or more flaps to direct the air streams, and is therefore more complex.

The invention is therefore intended to propose an improved installation intended to at least partially address the drawbacks in the prior art.

For this purpose, the invention relates to a heating, ventilation and/or air-conditioning installation for a motor vehicle passenger compartment comprising:
a first air intake duct,
a first air distribution duct comprising at least one first air outlet in the passenger compartment and communicating with the first air intake duct, and
a second air distribution duct including a second air outlet,

characterized in that said installation further comprises a second intake duct used exclusively for a recirculated air stream coming from the passenger compartment and that is in aeraulic communication with the second air distribution duct so that the second air distribution duct is supplied only with the recirculated air stream coming from the second air intake duct.

This solution makes it possible to implement aspiration used exclusively for recirculation in the second air intake duct.

The invention therefore proposes directing air streams to the air outlets from different sources or a shared source, as required. More specifically, an air stream from the first air intake duct, which may be fed either by an outside air stream or by a recirculated air stream or by a mixture of the two, may be directed to one or more first air outlets in the first air distribution duct.

Conversely, an air stream from a source different than the first air stream and that is entirely recirculated may be directed to a second air outlet separate from the first air outlets in the second air distribution duct.

The continuous recirculation of a portion of the air stream directed into the passenger compartment makes it possible to satisfy the need for rapid heating of the air, while a new outside air stream or one that is mixed with recirculated air may be sent to the windshield for the purpose of defogging, for example.

This solution obviates the need to provide bypass conduits for an air stream to be directed selectively in an air distribution duct.

Furthermore, since the source of the air streams directed to each duct is different, it is not necessary to provide flaps to split these two air streams, which are intended to feed firstly the first air distribution duct and secondly the second air distribution duct.

According to one aspect of the invention, the installation includes an engine fan able to direct air into the first air distribution duct and into the second air distribution duct, including:
a first portion in communication firstly with the first air intake duct and secondly with the first air distribution duct, and
a second portion in communication firstly with the second intake duct for a recirculated air stream and secondly with the second air distribution duct.

The specific recirculation is implemented on the side of the engine fan. This specific recirculation always works as soon as the engine fan has been actuated.

According to one embodiment, the engine fan has a wheel with a bowl made of solid material that extends between the first portion and the second portion of the engine fan. The bowl enables the engine fan to be split into two, thereby separating the air streams coming from the first air intake duct and from the second air intake duct from the source of the air streams.

According to one aspect of the invention, the engine fan has first blades extending from an outer peripheral edge of the bowl towards a first outer peripheral rim of the wheel and second blades extending, opposite the first blades, from the outer peripheral edge of the bowl towards a second outer peripheral rim of the wheel.

The engine fan has two opposing, separate aspiration regions. The second aspiration region is used exclusively for specific recirculation.

According to another aspect of the invention, the installation includes:
a volute containing the engine fan, and
sealing means separating the volute into two volumes, the first volute volume containing the first portion of the engine fan, and the second volute volume containing the second portion of the engine fan.

This volute is separated into two volumes, defining thus an upper portion and a lower portion.

The upper portion is in communication with the first air intake duct, which is a conventional air inlet that can be fed with outside air and/or with recirculated air, which passes through the volute before entering the first air distribution duct and flowing as far as the outlets, for example the de-icing outlets and head aeration outlets in the passenger compartment.

The lower portion is in communication with the second air intake duct used for the specific recirculation to create an air stream, which is also recirculated, in the second air distribution duct as far as an outlet, for example a footwell aeration outlet in the passenger compartment.

The sealing means may include a wall arranged between the two volumes of the volute and means for holding the wall in the volute. The wall makes it possible to simply partition the volute.

According to one embodiment, the holding means and the wall are formed as a single part.

The sealing means may include a substantially cylindrical peripheral skirt that holds the wall and that fits into a matching seat of the volute.

According to one embodiment, said installation includes at least one adjusting flap arranged in the second air intake duct to control the air flow rate of the recirculated air stream. The adjusting flap dedicated to recirculation makes it possible to manage the recirculated air stream, for example as a function of parameters of the vehicle, such as the speed of the vehicle.

According to one aspect of the invention, the installation includes a separating partition arranged between the first air distribution duct and the second air distribution duct.

According to another aspect of the invention, the installation includes heat treatment means for the air stream arranged in the first air distribution duct and in the second air distribution duct. Said heat treatment means are common to both air distribution ducts.

Said heat treatment means may include respectively an internal partition for separating the air streams flowing through the first air distribution duct and the second air distribution duct.

The partition between the two distribution ducts and the internal partitions at the heat treatment means enable the separation between the two air streams until delivery in the respective air outlets.

According to one embodiment of the invention, a switching flap may be used to communicate the two air distribution ducts, for example to send more air to one of the air outlets.

According to one specific embodiment, said at least one first outlet is a de-icing outlet oriented towards the windshield of said vehicle or a head-aeration outlet for the passengers in the passenger compartment of said vehicle, and the second outlet is an aeration outlet oriented towards the feet of the passengers in the passenger compartment.

Heating can be achieved more rapidly by sending a recirculated air stream towards the feet only. The proportion of new outside air and of recirculated air to be directed towards the head-aeration outlets and defogging/de-icing outlets may be adjusted according to the de-icing requirements.

Other characteristics and advantages of the invention are set out in greater detail in the description below, given by way of non-limiting example and the attached drawings, in which:

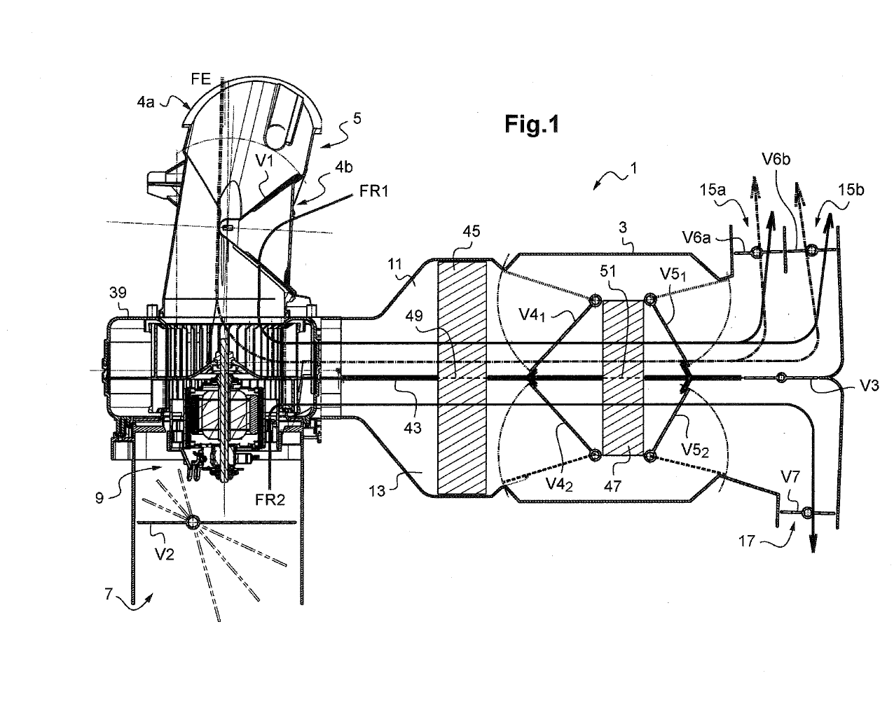

FIG. 1 is a cross sectional view of a two-stage heating, ventilation and/or air-conditioning installation according to the invention,

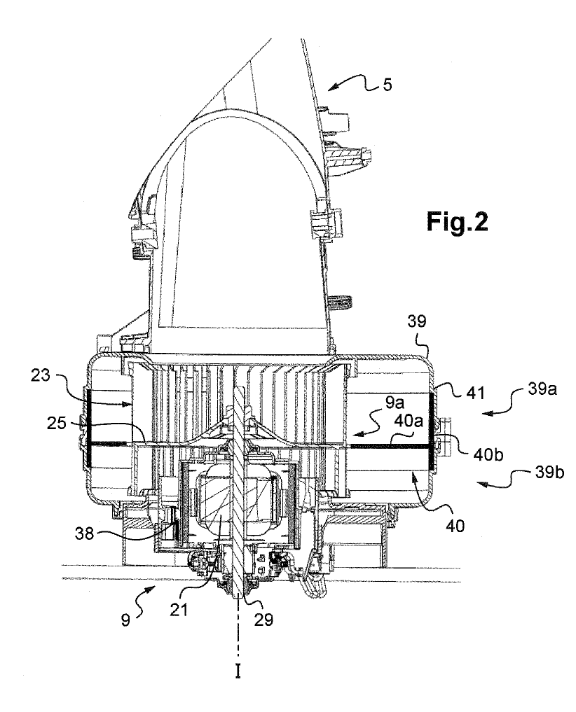

FIG. 2 is a schematic view of a volute in the installation in FIG. 1, including an engine fan,

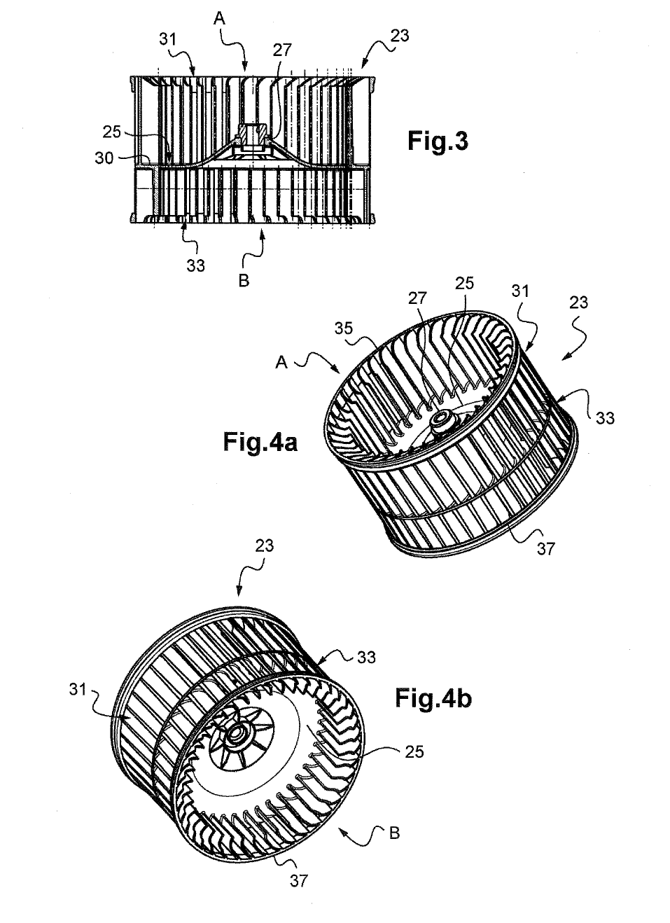

FIG. 3 shows the wheel of the engine fan in FIG. 2,

FIG. 4a is a first perspective view of the wheel in FIG. 3, and

FIG. 4b is a second perspective view of the wheel in FIG. 3.

In these figures, substantially identical elements are identified using the same reference signs.

FIG. 1 is a schematic view of a heating, ventilation and/or air-conditioning installation 1 designed to be fitted to a motor vehicle to control the aerothermal parameters of the air streams ducted to one or more zones of the passenger compartment of the vehicle.

The installation 1 has a casing 3 including:
a first air intake duct 5,
a second air intake duct 7,
an engine fan 9, also referred to as a blower, for blowing air into the installation 1,
a first air distribution duct 11,
a second air distribution duct 13, and
several air outlets 15a, 15b and 17.

The casing 3 includes a first intake vent 4a for bringing an outside air stream FE from outside the vehicle into the first air intake duct 5, enabling same to flow in the internal volume delimited by the casing 3.

The casing 3 also includes a second intake vent 4b for taking a first recirculated air stream FR1 from the passenger compartment of the vehicle, to be recirculated inside the internal volume delimited by the casing 3.

Naturally, the air inlets may be inverted, i.e. the recirculated air FR1 may be applied to the inlet 4a and the outside air FE may be applied to the inlet 4b.

The first air intake duct 5 may also be fed by the outside air stream FE or the first recirculated air stream FR1, or by a mixture of the outside air stream FE and the recirculated air stream FR1. The outside air stream FE and the first recirculated air stream FR1 can be mixed together in the first air intake duct 5.

For this purpose, an air mixing member, such as a first mixing flap V1, mounted pivotingly, enables the outside air stream FE and the recirculated air stream FR1 to be created in the first air intake duct 5 in the desired proportions.

The mixing flap V1 is moveable between two end closed positions. In a first closed position, referred to as the recirculation position, the mixing flap V1 prevents the outside air stream FE from flowing towards the first air intake duct 5 while enabling the first recirculated air stream FR1 to flow towards the first air intake duct 5. In the second closed position, referred to as the outside position, the mixing flap V1 prevents the recirculated air stream FR1 from flowing towards the first air intake duct 5 while enabling the outside air stream FE to flow towards the first air intake duct 5.

The mixing flap V1 is arranged such that it controls, in the intermediate positions, the proportion of the outside air stream FE and of the first recirculated air stream FR1 entering the first air intake duct 5.

The travel of the first flap V1 is shown schematically using dotted lines from the extremity of the first flap V1 in FIG. 1.

The second air intake duct 7 is used exclusively for inserting a second recirculated air stream FR2 taken from the passenger compartment and flowing back through the installation 1.

A second flap V2 may be provided inside the second air intake duct 7. This is an adjusting flap mounted pivotingly in order to control the flow rate of the second recirculated air stream FR2.

Different positions of the second flap V2 for managing the flow rate of the second recirculated air stream FR2 are shown by way of example in FIG. 1. The flow rate may for example be managed as a function of the speed of the vehicle.

The flow rate of this specific recirculation may be in the range 10-50% of the flow rate of the aspirated air stream from the first air intake duct 5.

However, the adjusting flap V2 should not be fully closed since it must let a certain quantity of air through to cool the engine.

The engine fan, also referred to as the blower 9, is arranged to create an air stream from the first air intake duct 5 or from the second air intake duct 7 into the installation 1 and subsequently towards the air outlets 15a, 15b, 17, for example a defogging/de-icing outlet 15a, a head-aeration outlet 15b and a footwell aeration vent 17.

The air supplied through the defogging/de-icing vent 15a makes it possible to supply one or more nozzles arranged around the windshield of the vehicle. The head-aeration outlet 15b makes it possible to ventilate an upper zone of the passenger compartment, while the footwell aeration outlet 17 makes it possible to ventilate a lower zone of the passenger compartment.

More specifically, the blower 9 is arranged downstream of the first intake duct 5 with reference to the direction of flow of the outside air stream FE and of the first recirculated air stream FR1 such as to create an air stream from the first air intake duct 5 into the installation 1, and more specifically into the first air distribution duct 11, and subsequently towards the outlets 15a and 15b.

The blower 9 is also arranged downstream of the second intake duct 7 with reference to the direction of flow of the second recirculated air stream FR2 such as to create an air stream from the second air intake duct 7 into the installation 1, and more specifically into the second air distribution duct 13, and subsequently towards the outlet 17.

The blower 9 makes it possible for either outside air FE taken from outside the passenger compartment, or recirculated air taken from inside the passenger compartment, referred to as the first recirculated air stream FR1, or a mixture of the two to be blown into the first air distribution duct 11, and for a continuous recirculated air stream taken from inside the passenger compartment, referred to as the second recirculated air stream FR2, to be blown into the second air distribution duct 13.

For this purpose, as shown more clearly in FIG. 2, the blower 9 has:
a first portion 9a, referred to as the upper portion, in communication with the first air intake duct 5 and with the first air distribution duct 11, and
a second portion 9b, referred to as the lower portion, in communication with the second air intake duct 7 and with the second air distribution duct 13.

The lower portion 9b is therefore used exclusively for continuous recirculation. This lower portion 9b for continuous recirculation may constitute between 10% and 35% of the height of the blower 9.

More specifically, the blower 9 includes a fan and a motor 21 able to drive the fan in rotation about a drive shaft I.

The fan has a wheel 23. The electric motor 21 is able to drive the wheel 23 in rotation such as to create an air stream inside the installation 1.

According to the embodiment illustrated, the wheel 23 is cylindrical.

The wheel 23, shown more clearly in FIG. 3, includes a bowl 25.

The bowl 25 is made of solid material such as to form a sealed separation between the upper portion 9a of the blower and the lower portion 9b of the blower 9. This separation created by the bowl 25 prevents the air stream coming from the first air intake duct 5 from entering the second distribution duct 13 via the lower portion 9b of the blower 9, and conversely prevents the air stream coming from the second air intake duct 7 from entering the first distribution duct 11 via the upper portion 9a of the blower 9.

The bowl 25 has a hub 27 substantially at the center thereof, the function of which is to mechanically link the wheel 23 to a drive shaft 29. The bowl 25 also has an outer peripheral edge 30.

Furthermore, the wheel 23 also has blades or vanes 31, 33 around the perimeter of same.

With reference to FIGS. 3 and 4a, 4b, first blades 31 extend from the outer peripheral edge 30 of the bowl 25 towards a first outer peripheral rim 35 of the wheel 23 and second blades 33 extend from the outer peripheral edge 30 of the bowl 25, opposite the first blades 31, towards a second outer peripheral rim 37.

The blower 9 therefore has an open first end face A delimited by the first outer peripheral rim 35 and an open second end face B facing the open first end face A and delimited by the second outer peripheral rim 37.

The blower 9 has a first air aspiration region and a second air aspiration region. According to the embodiment illustrated, the first air aspiration region is located on the side of the first end face A of the cylindrical wheel and the second air aspiration region is located on the side of the second end face B of the cylindrical wheel. The wheel 23 of the blower aspirates the air via the two opposing open end faces A and B of same.

In the example illustrated in FIG. 1, the air coming from the first air intake duct 5 is evacuated on the side of the upper portion 9a of the blower in a direction perpendicular to the intake direction of the air through the open first end face A. Moreover, the recirculated air FR2 coming from the second air intake duct 7 is evacuated on the side of the lower portion 9b of the blower 9 in a direction perpendicular to the intake direction of the air through the open second end face B.

With reference to FIG. 2, the motor 21 includes a cage 38 that delimits an internal volume of the motor 21.

The motor 21 includes a drive shaft 29 that passes through the cage 38, from one side to the other along the axis I. According to the example illustrated, the drive shaft 29 protrudes more on one side of the motor 21 than on the other, and passes through the hub 27 of the bowl 25 of the wheel 23 to drive the wheel 23 in rotation.

Furthermore, the casing 3 includes a volute 39 containing the blower 9.

The volute 39 is divided into two volumes: a first volume 39a containing the upper portion 9a of the blower 9 and a second volume 39b containing the lower portion 9b of the blower 9.

The second volume 39b is therefore used exclusively for continuous recirculation and may constitute between 10% and 35% of the height of the volute 39.

In order to prevent any aeraulic communication between the upper portion 9a and the lower portion 9b, the volute 39 includes sealing means 40 arranged between the two volumes 39a and 39b.

These sealing means 40 include a wall 40a separating the two volumes 39a and 39b.

The wall 40a is arranged permanently in the volute 39 to separate these two air streams coming from the first intake duct 5 and from the second intake duct 7, thereby enabling continuous recirculation of the air stream at the second distribution duct 13. The wall 40a is arranged in a fixed position in the volute 39 about the blower 9.

The wall 40a at the blower 9 therefore enables a separation into two portions from the source of the incoming air streams before distribution into the respective ducts 11 or 13.

The sealing means 40 also include means 40b for holding the wall 40a in the volute 39.

According to the embodiment illustrated, the holding means 40b and the wall 40a are formed as a single part.

By way of example, the sealing means 40 may be a substantially cylindrical peripheral skirt 40b in the example illustrated. The peripheral skirt 40b is connected to the wall 40a extending substantially vertically in relation to the plane defined by the wall 40a on either side of the wall 40a. In the example illustrated in FIG. 2, the peripheral skirt 40b extends more on the side of the wall 40a facing the first volute volume 39a in communication with the first air intake duct 5.

The peripheral skirt 40b and the wall 40a may be formed as a single part.

Furthermore, the peripheral skirt 40b fits into a matching seat of the volute 39. According to the example shown, this seat is formed by shoulders 41 on the side walls of the volute 39. The cylindrical peripheral skirt 40b therefore forms means for holding the wall 40a in the volute 39.

An installation 1 is described above with a single wheel 23 driven by a motor 21 to bring the air both into the first air distribution duct 11 and into the second air distribution duct 13. As an alternative, an installation may have two wheels respectively associated with one air distribution duct 11 or 13.

Again with reference to FIG. 1, the two air distribution ducts 11 and 13 are also separated by a separating partition 43 arranged between the two air distribution ducts 11 and 13. The separating partition 43 is airtight.

The casing 3 therefore has two stages separated by this partition 43, the first stage defining the first aired distribution duct 11 and the second stage defining the second air distribution duct 13.

Thus, the air stream aspirated by the upper portion 9a of the blower 9 coming from the first air intake duct 5 flows in the first distribution duct 11 towards the outlets 15a, 15b with no aeraulic communication with the second air distribution duct 13. Equally, the recirculated air stream FR2 aspirated by the second portion 9b of the blower 9 coming from the second air intake duct 7 flows in the second air distribution duct 13 towards the outlet 17 without aeraulic communication with the first air distribution duct 11.

However, if communication between the two air distribution ducts 11 and 13 is desired, the separating partition 43 need not extend along the entire length of the casing 3 and may include a switching flap V3. The flap V3 is mounted pivotingly between a closed position, as illustrated in FIG. 1, and an open position, enabling communication between the two air distribution ducts 11 and 13.

This may be advantageous if a larger quantity of air is required, for example around passengers' feet.

Furthermore, the casing 3 also contains heat treatment means 45, 47 for the air before the air is evacuated from the casing 3 into the passenger compartment.

The heat treatment means 45, 47 are arranged in the first air distribution duct 11 and in the second distribution duct 13. More specifically, the heat treatment means 45, 47 are common to both air distribution ducts 11 and 13.

In this case, the heat treatment means 45, 47 may comprise respectively an internal partition 49, 51 making it possible to separate the air streams coming from the first air inlet duct 5 or from the second air intake duct 7 and passing through the heat treatment means 45 and 47.

The heat treatment means 45, 47 are in particular an evaporator 45 provided to cool the air passing through same and a heating device such as a radiator 47 designed to heat said air. The radiator 47 may be associated with electrical positive temperature coefficient (PTC) resistors. The heating device may be an air/water exchanger or an air/oil exchanger, i.e. one in which there is a heat exchange between the air and the water or the oil.

In each air distribution duct 11, 13, distribution flaps V4₁, V4₂, V5₁, V5₂ may be arranged upstream and downstream of the radiator 47.

In the first air distribution duct 11, the flap V4, arranged upstream of the radiator 47 and the flap V5₁ arranged downstream of the radiator 47 in relation to the direction of flow of the air stream coming from the first air intake duct 5 are able to enable or prevent the passage through the radiator 47 of the air stream coming from the evaporator 45. Thus, the air stream coming from the evaporator 45 may bypass the radiator 47.

The flaps V4₁ and V5₁ are mounted pivotingly between two end positions enabling or preventing the passage through the radiator 47 of any air stream coming out of the evaporator. The flaps V4₁ and V5₁ may be switched to intermediate positions to create one air stream to be heated in the radiator 47 and one air stream that is not to be heated and does not pass through the radiator 47,

The travel of the flaps V4₁ and V5₁ is shown schematically using dotted lines in FIG. 1.

Similarly, in the second air distribution duct 13, the flap V4₂ arranged upstream of the radiator 47 and the flap V5₂ arranged downstream of the radiator 47 in relation to the direction of flow of the recirculated air stream FR2 coming from the second air intake duct 7 are able to enable or prevent the passage through the radiator 47 of the air stream coming from the evaporator 45. Thus, the air stream coming from the evaporator 45 may bypass the radiator 47.

The flaps V4₂ and V5₂ are mounted pivotingly between two end positions enabling or preventing the passage through the radiator 47 of any air stream coming out of the evaporator. The flaps V4₂ and V5₂ may be switched to intermediate positions to create one air stream to be heated in the radiator 47 and one air stream that is not to be heated and does not pass through the radiator 47.

The travel of the flaps V4₂ and V5₂ is shown schematically using dotted lines in FIG. 1.

Finally, each air outlet 15a, 15b, 17 may be provided with a respective distribution flap V6a, V6b and V7 that can be moved between an open position in which the air distribution flap V6a, V6b and V7 permits air to pass through the air outlet 15a, 15b, 17 to which the air distribution flap V6a, V6b and V7 is fitted, and a closed position in which the air distribution flap V6a, V6b and V7 prevents such passage.

Thus, such an installation 1 including a two-stage casing 3 makes it possible to manage the air using the first air intake duct 5 exclusively for the first stage by drawing outside air, recirculated air or a mixture of the two, and by always drawing the air for the second stage directly from the passenger compartment.

The first stage feeds in particular the upper aeration outlets and the defogging/de-icing outlets, while the second stage feeds the lower aeration outlets intended for users' feet.

By continuously recirculating the air stream directed towards the feet, heating is achieved more rapidly. The air stream for the first stage may be distributed as required for de-icing and/or thermal comfort in the passenger compartment, and in particular a greater proportion of the outside air stream, which is drier than the recirculated air stream, may be used to prevent fogging of the windshield, for example.

The two air streams are separated at source by splitting the blower 9 such that there is no need to provide a complicated air management system with flaps required to recirculate the air stream for the second stage of the casing 3.

The separation between the two stages of the casing 3 may be achieved simply by using a partition 43 between the two air distribution ducts 11, 13.

1. A heating, ventilation and/or air-conditioning installation for a motor vehicle passenger compartment comprising:
a first air intake duct;
a first air distribution duct comprising at least one first air outlet in the passenger compartment that is in communication with the first air intake duct;
a second air distribution duct including a second air outlet; and
a second intake duct used exclusively for a recirculated air stream coming from the passenger compartment and that is in aeraulic communication with the second air distribution duct so that the second air distribution duct is supplied only by the recirculated air stream coming from the second air intake duct.

2. The installation as claimed in claim 1, further comprising:
an engine fan able to blow air into the first air distribution duct and into the second air distribution duct, including:
a first portion in communication firstly with the first air intake duct and secondly with the first air distribution duct, and
a second portion in communication firstly with the second intake duct for duct.

3. The installation, as claimed in claim 2, wherein the engine fan has a wheel with a bowl made of solid material and extending between the first portion and the second portion of the engine fan.

4. The installation as claimed in claim 3, wherein the engine fan has first blades extending from an outer peripheral edge of the bowl towards a first outer peripheral rim of the wheel and second blades extending, opposite the first blades, from the outer peripheral edge of the bowl towards a second outer peripheral rim of the wheel.

5. The installation as claimed in claim 2, including:
a volute containing the engine fan; and
sealing means separating the volute into two volumes, the first volute volume containing the first portion of the engine fan and the second volute volume containing the second portion of the engine fan.

6. The installation as claimed in claim 5, wherein the sealing means include a wall arranged between the two volumes of the volute and means for holding the wall in the volute.

7. The installation as claimed in claim 6, wherein the holding means and the wall are formed as a single part.

8. The installation as claimed in claim 6, wherein the sealing means include a substantially cylindrical peripheral skirt that holds the wall and that fits into a matching seat of the volute.

9. The installation as claimed in claim 1, including at least one adjusting flap arranged in the second air intake duct to adjust the air flow in the recirculated air stream.

10. The installation as claimed in claim 1, including a separating partition arranged between the first air distribution duct and the second air distribution duct.

11. The installation as claimed in claim 1, including heat treatment means for the air stream arranged in the first air distribution duct and in the second air distribution duct, said heat treatment means:
being common to the two air distribution ducts, and
including respectively an internal separating partition for separating the air stream flowing through the first air distribution duct and the second air distribution duct.

12. The installation as claimed in claim 1, wherein said at least one first outlet is a de-icing outlet oriented towards the windshield of said vehicle or a passenger head-aeration outlet in the passenger compartment of said vehicle, and the second outlet is an aeration outlet oriented towards the feet of the passengers in the passenger compartment.
